(19) United States
(12) Patent Application Publication
(10) Pub. No.: US 2002/0059489 A1
(43) Pub. Date: May 16, 2002

(54) Remote printing

(76) Inventors: Ray Charles Davis, Spring City, TX (US); Bobby Ernest Blythe, Montgomery, TX (US)

Correspondence Address: Matthew R. Schantz, Woodard, Emhardt, Naughton, Moriarty and McNett, Bank One Center/Tower, 111 Monument Circle, Suite 3700, Indianapolis, IN, 46204-5137, US

(21) Appl. No.: 10/010,303

(22) Filed: Nov. 13, 2001

Related U.S. Application Data
(60) Provisional application No. 60/248,467, filed on Nov. 14, 2000.

(51) Int. Cl. B41J 1/00

(52) U.S. Cl. 710/72; 358/1.1

(57) ABSTRACT

A system and method are disclosed for remotely printing documents from computer applications that generate printable data. In one form, printable data is transferred from a local computer to a remote computer or printer in a data format native to the application. In another form, a relay server provides a store-and-forward buffer between the local computer and remote computer or printer. In another form, a computer-readable medium is encoded with a program to facilitate the transfer of remote print jobs. In still another form, a local computer maintains a list of local and remote printers that can be used. When a print request is received, the system automatically traverses the list to find the first available printer and sends the print job to it.

### REFERENCE TO RELATED APPLICATIONS

Priority is claimed to U.S. Provisional Patent Application 60/248,467, filed Nov. 13, 2000, and U.S. patent application Ser. No. 09/747,457, filed Dec. 22, 2000.

### BACKGROUND

The present invention relates to the remote production of hard copy from electronic documents. More specifically, the present invention relates to a system and method for remotely printing documents that is approximately as convenient as local printing.

As computers are used more and more often for personal and business purposes in a wide variety of locations, there is frequently a desire to produce a hard copy of documents at a location distant from ones own work station, or to transmit the document (or a copy of the document) to a distant location. For example, a letter may be generated using a word processing program on a nearby computer, only to be mailed across the country to another office. In other situations, business travelers carry laptop computers to enable them to create and modify documents while they are outside of their office. Such a traveler who wishes to generate hard copies of documents while traveling must also carry a printer in addition to the laptop computer. This adds undesirable weight and bulk to the equipment that must be carried. These and other problems may be addressed by a system that permits a user to print a hard copy from a remote location, i.e., on a printer that is not directly connected to the user's computer.

The prior art includes some examples of remote printing systems, all of which include one or more deficiencies in addressing the various situations in which a user might want to print a hard copy of a document that is not directly connected to his computer. An example includes one or more direct connections, such as dedicated leased telephone lines connecting the workstation to the remote printer. This method has the disadvantage of requiring a permanent (and often expensive) telecommunications link between the devices. In situations where the user travels to many locations, such a solution may be prohibitively expensive. Such a solution also becomes prohibitively expensive when many destinations for the hard copy exist.

In an alternative system, dial-up telephone lines are used to carry communications between the computer and the printer. This solution addresses many of the problems described above, but also fails to meet the requirements of many users. For example, the required modems and networking equipment are frequently complex and difficult to administer. Similar networking arrangements using a wide-area network (WAN) to connect local-area networks (LANs) in various locations also suffer from administrative complexities and prohibitive cost.

Another remote printing scheme uses Internet e-mail technology. In one such arrangement, the sending computer uses special software to convert print jobs into e-mail print jobs. At the receiving end, the receiving computer and/or printer must be equipped with compatible software for receiving and printing the e-mail print jobs. In another such system, an e-mail server converts e-mail print jobs into facsimile transmissions sent over telephone lines using facsimile transmission protocols. The compatibility and complexity problems involved in such systems render them difficult to administer and use.

A simpler existing technique by which a hard copy of a document may be produced at a remote location is to attach the document to an e-mail message. This method requires human intervention, such as opening the document and issuing a print command. In many forms of this system, the recipient is also able to modify the document, which ability may be undesirable to the sender.

There is thus a need for further contributions and improvements to remote printing technology.

### SUMMARY

It is an object of the present invention to provide an improved system and method for remote printing. Another object is to provide an improved system and method for allowing an authorized user to produce a hard copy of a document from a given computer on a printer that is not connected directly to that computer or its LAN.

These objects and others are achieved by various forms of the present invention.

### BRIEF DESCRIPTION OF THE DRAWINGS

FIG. 1 is a schematic diagram of a system for remote printing.

FIG. 2 is a block diagram showing communication relationships in the remote printing system of FIG. 1.

FIG. 3 is a block diagram of software components in the remote printing system of FIG. 1, showing the flow of data between them.

FIG. 4 is a block diagram of the software components in an alternative embodiment of the remote printing system of FIG. 1, showing the flow of data between them.

FIG. 5 is a block diagram of software components in an alternative embodiment of the remote printing system of FIG. 1, showing the flow of data between them.

### DESCRIPTION OF THE ILLUSTRATED EMBODIMENTS

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

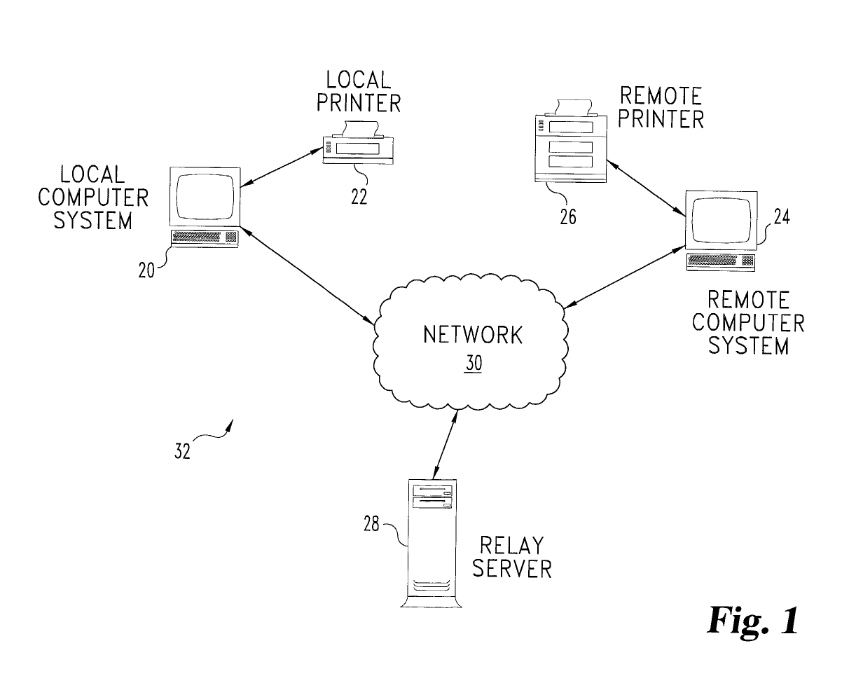

Generally, the remote printing system illustrated in FIGS. 1-5 provides a facility for a user of local computer system 20 having local printer 22 to print to remote printer 26, which is attached to remote computer system 24. Network 30 carries data between the computer systems. In some embodiments discussed herein, relay server 28 stores and forwards data as it passes between various other components of overall system 32.

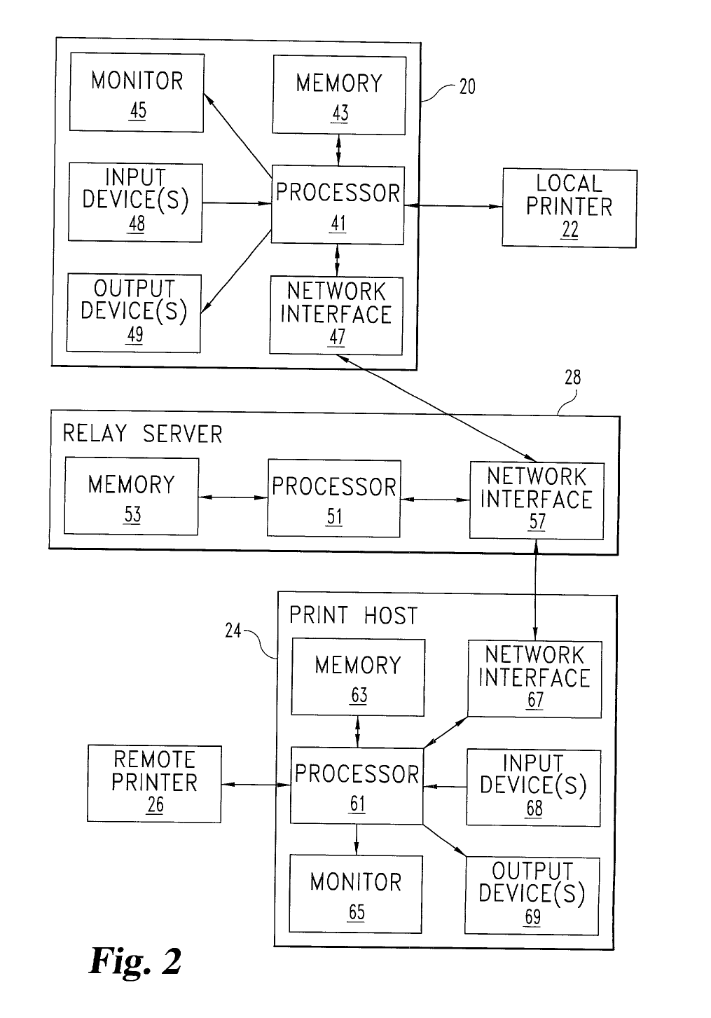

Two different embodiments of a remote printing system according to the present invention will be discussed herein. The hardware components and communication relationships of the first, “server-mediated” embodiment will now be discussed with reference to FIG. 2. It should be understood that in each instance where “communication” between components is described and not characterized as being through a “direct connection,” one or more additional components may be provided in addition to those shown or described to facilitate that communication, such as bridges, routers, or even other computers.

Further, as used herein, a “direct connection” between a printer and a processor or computer refers to an arrangement in which communication is enabled between the components, but that communication does not pass through network hardware, such as a router or network switch. A “LAN connection” between a printer and a processor or computer refers to an arrangement in which communication is enabled between the components, and that communication passes through network components owned or controlled by a single entity.

Local computer system 20 comprises processor 41, memory 43, monitor 45, network interface 47, zero or more optional input device(s) 48, and zero or more optional additional output device(s) 49. Relay server 28 comprises processor 51, memory 53, and network interface 57. Like local computer system 20, remote computer system 24 comprises a processor 61, memory 63, monitor 65, network interface 67, zero or more optional input device(s) 68, and zero or more output device(s) 69. Processor 41 is directly connected to local printer 22 via a parallel or USB port or serial port such as RS232, RS422, Firewire (IEEE standard 1394) or similar connection protocol as is known to those skilled in the art. Processor 41 may alternatively communicate with printer 22 via a LAN. Processor 61 likewise communicates with remote printer 26 via a direct connection or LAN connection as known in the art.

It should be understood that local computer 20 can include more than one processor or CPU and more than one type of memory, where memory 43 is representative of one or more types. Furthermore, it should be understood that while one local computer 20 is illustrated, more computers can be connected thereto in alternative embodiments. Processor 41 can be comprised of one or more components configured as a single unit. Alternatively, when of a multi-component form, processor 41 can have one or more components located remotely relative to the others. One or more components of processor 41 can be of the electronic variety comprising digital circuitry, analog circuitry, or both. In one embodiment, processor 41 is of a conventional, integrated circuit microprocessor arrangement, such as one or more PENTIUM III or PENTIUM 4 processors supplied by INTEL Corporation.

Memory 43 can include one or more types of solid-state electronic memory, magnetic memory, or optical memory, just to name a few. By way of non-limiting example, memory 43 can include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a DVD or CD ROM); a magnetically encoded hard disk, floppy disk, tape, or cartridge media; or a combination of any of these memory types. Also, memory 43 can be volatile, nonvolatile, or a hybrid combination of volatile and nonvolatile varieties.

Network 30 can be in the form of a Local Area Network (LAN), Wide Area Network (WAN) such as the Internet, or other network type as would occur to those skilled in the art. Local computer 20 includes monitor 45. Although not shown to preserve clarity, local computer 20 can also include one or more operator input devices 48 such as a keyboard, mouse, track ball, light pen, and/or microphone, to name just a few representative examples. Also, besides monitor 45, zero or more other output devices 49 can be included such as loudspeaker(s).

In relay server 28, processor 51, memory 53, and network interface 57 may take any of the forms described above in relation to processor 41, memory 43, and network interface 47, respectively. Each corresponding item may be the same as or different from the corresponding component in local computer 20. Likewise, the components of print host 24 (processor 61, memory 63, monitor 65, network interface 67, zero or more other input device(s) 68, and zero or more other output device(s) 69), may each take one or more forms described above in connection with the corresponding components 41, 43, 45, 47, 48, and 49, respectively, discussed above in relation to local computer 20. Furthermore, while the general communication patterns between hardware components in the illustrated embodiment are shown in FIG. 2, any of the communication paths illustrated may pass through additional components not shown in FIG. 2, such as network 30 (see FIG. 1), ports, connectors, switches, and the like, as would occur to one skilled in the art.

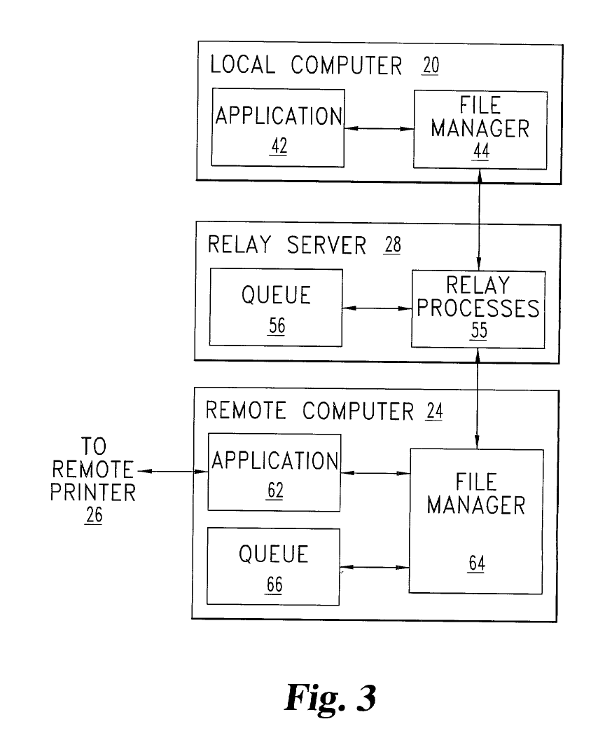

Referring now to FIG. 3, an overview of the primary software components in one illustrated embodiment will be presented. Application 42 generates or collects printable data such as, by way of non-limiting example, word processing documents, graphical presentations, images, World-Wide Web content, spreadsheets, and e-mail messages. If the user of local computer 20 wishes to print such data on remote printer 26, he or she selects a “Print” command in the user interface of application 42. Application 42 proceeds with a “printer discovery” process, by which application 42 obtains information regarding the local and remote printers available for use by local computer 20. In the illustrated embodiment, application 42 sends the document to file manager 44 with specific destination printer and print option information. File manager 44 connects to relay server 28 and sends the printable data to one of the relay processes 55. The relay process 55 stores the data in queue 56 for later use.

The file manager 64 in remote computer 24 periodically polls relay server 28 for waiting print jobs by connecting to one of relay processes 55 and sending a command to check for such jobs. If any data is queued for remote printer 26, file manager 64 retrieves the data and stores it in print queue 66. When remote printer 26 is available, file manager 64 opens an instance of application 62 with a request to print the data that had been stored in queue 66. Application 62 automatically opens, loads the data, and prints it on remote printer 26.

The result code for the print job is returned from printer 26 to application 62, which in turn provides the result information (success or failure of the print job) to file manager 64. Application 62 then closes itself to conserve memory and processing resources. File manager 64 communicates the result code to a relay process 55. File manager 44 periodically polls relay processes 55 to determine whether the result code is available and, if so, download that code. File manager 44 may inform the user of the result of the print job through application 42, directly through the user interface (not shown) provided by the operating system(s) of local computer 20, by recording the results in one or more log files, or not at all.

If the various components are sufficiently responsive, and the connections are sufficiently stable, some or all of the communications described above may avoid use of queue 56 and queue 66 and the poling mechanism described in relation to relay processes 55. Instead, connections between the components (application 42, file manager 44, relay processes 55, file manager 64, application 62, and remote printer 26) are maintained while the system communicates and executes the print job and returns the result codes.

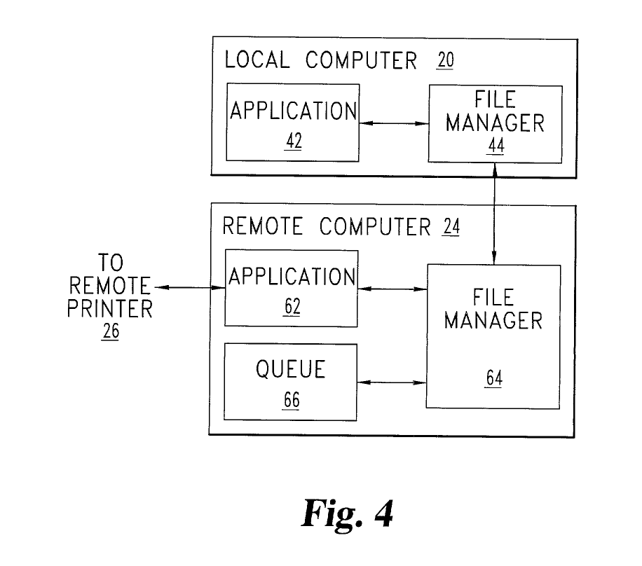

In an alternative embodiment, which will now be discussed with reference to FIG. 4, file managers 44, 64 communicate directly, without the use of relay server 28. In this embodiment, when file manager 44 receives a request to print a print job, it links directly to file manager 64, transmits the print job information, and waits for the result code. Alternatively, as discussed in relation to the embodiment shown in FIG. 3, the link between file manager 44 and file manager 64 may be terminated while the print job is pending, then re-established after the print job is completed for reporting the result code back to file manager 44 and application 42.

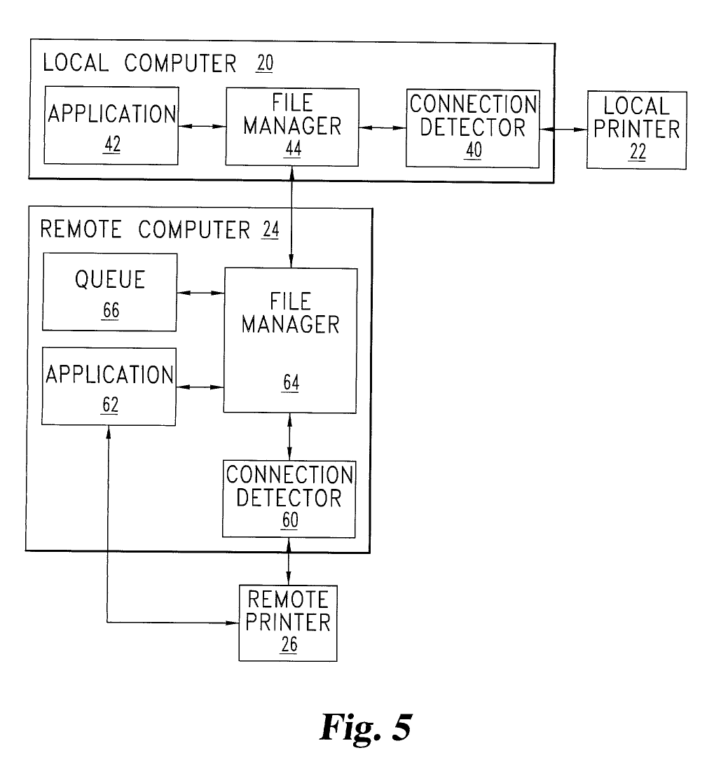

Another form of the present invention will now be discussed in relation to FIG. 5. In this embodiment, local computer 20 additionally comprises connection detector 40, which is capable of determining whether local printer 22 is actually in communication with local computer 20. Likewise, connection detector 60 is arranged and configured to detect whether remote printer 26 is operatively connected to file manager 64. Various methods are known in the art for providing such connection detection, including methods that use hardware, software, or a combination thereof.

File manager 44 maintains a prioritized list of printers that it uses to handle print jobs. This list may be an ordered list of one or more specific printers (by “printer identifier,” e.g., name, serial number, other unique identifier, or port) and/or classes (by “group identifier,” e.g., local before remote printers, color before monochrome printers, or routing information (based on the network through which local computer 20 sends print jobs for the particular printer). When application 42 sends a print job to file manager 44, file manager 44 iterates through the list until a printer is found on which the print job can be printed. This iteration is performed by using connection detector 40 to determine the availability of one or more local printers 22, and using connection detector 60 (via file manager 64) to determine the availability of one or more remote printers 26. Alternatively or additionally, file manager 44 may maintain a list of remote printers 26 that are connected and/or connectable to local computer 20, for example, by accepting login/logout signals and/or by periodically polling each printer, then when a print job arrives, the local list may be used instead of attempting to remotely detect the connectability of various remote printers 26.

In another form of the invention, system 32 comprises a local computer having a first processor and a first memory encoded with a first set of programming instructions executable by the first processor to (1) execute a first instance of an application having at least one native data format, and (2) accept a request to print first data associated with the application. The system further comprises a remote printer and a remote computer, in communication with the local computer and the remote printer, having a second processor and a second memory encoded with a second set of programming instructions executable by the second processor to (1) execute a second instance of the application (2) receive the request, and (3) in response to the receiving, automatically print the first data on the remote printer using the second instance of the application. In this form, the first data is communicated from the local computer to the remote computer in at least one of the native data format(s) of the application.

In a variation of this form, a relay computer is configured and adapted to receive the first data from the local computer and send the first data to the remote printer. In some embodiments of this variation, the remote computer periodically polls the relay computer to determine whether one or more print jobs intended for the remote printer are waiting to be sent. If so, the remote computer retrieves the print jobs and prints them on the remote printer.

Another form of the invention is a system comprising at least one remote printer and a local computer connectable to one or more local printers and in communication with the remote printer(s) via a network. The local computer comprises a means for detecting whether one or more local printers are connected, a processor, and a memory encoded with programming instructions executable by the processor to (1) maintain an ordered list (by identity, category, or capability) of at least two printers, including at least one of the local printer(s) and at least one of the remote printer(s), (2) accept a request to print a document, (3) automatically traverse the ordered list to find a destination printer, which is the first printer on the ordered list that is then accessible to the local computer, and (4) print the document on the destination printer.

In a variation of this form, a first one of the local printers is directly connected to the local computer through a LAN.

In another variation, the system also includes a remote computer in communication with the local computer, where the local computer can access the remote printer through the remote computer. In some embodiments of this variation, the remote printer is directly connected to the remote computer.

Another form of the invention is a method comprising (1) receiving a print job from a source computer, (2) accepting a polling signal from a destination computer, (3) responding to the polling signal by sending the print job to the destination printer for printing, (4) receiving a print job result signal from the destination computer, and (5) sending the print job result signal to the source computer. In one variation of this form, the print job comprises document data and printing parameters. In another variation, the print job comprises document data in a format not directly printable by the remote printer. In one embodiment of this variation, the format is a word processing application data format, while in other embodiments, the format is a spreadsheet application data format.

In some embodiments of the invention, users of local computers 20 and print hosts 24 are authenticated by a login procedure on relay server 28. Users of print hosts 24 log in to make their directly connected and/or LAN-connected printers 26 available to users of computers 20, or to cancel or remove that availability. This authentication may utilize user name/password combinations, digital certificates, biometric authentication, or other authentication techniques as would occur to one skilled in the art. Access rights may be maintained by access control lists, group certificate management (for example, PKI architectures), or other methods as would occur to one skilled in the art. In various embodiments, allowing access to a remote printer 26, users of print hosts 24 may allow access to specific individual users or to groups of users of the system, such as users associated with a particular corporation, user group, or class.

In some embodiments, a single file format is processed by the system in all exchanges of printable data, while in other systems, multiple formats are permitted. In the latter type of embodiment, different document types may be distinguished by the print host 24 using envelope information (such as MIME-type headers, fields, or extensions), “magic numbers,” the format and/or content of the data itself, or other techniques as would occur to one skilled in the art. When data of multiple formats travels through the system, various embodiments of the invention use various methods to translate those formats into data that can be directly interpreted by the printer. In some embodiments the source (local) computer does not interact directly with the remote printer, so it is not required to have a driver installed for each such remote printer it accesses.

Further, in some embodiments, the local computer can use the remote printer regardless of the local computer's operating system-even if no printer driver exists for the remote printer on that operating system. Still further, various embodiments of the invention will combine and/or separate the various functions described herein into one or more objects, modules, applications, devices, and the like, as would occur to one skilled in the art.

In some embodiments, the destination printer is selected by the user of local computer 20 upon initiation of the print job. In these situations, the destination printer information is sent through the system as part of the print job. In other embodiments, a group of printers identified by unique identifiers, a class of printers identified by capability, or a list of classes of printers is selected upon initiation of the print job, and resolution of that ambiguity is made by the relay server 28 using current printer availability information (or subsequent availability information, if no printer within the selected group or class(es) is then available).

Data compression and encryption may be incorporated into the systems described above without undue experimentation by those skilled in the art. As a non-limiting example, the digital certificates described above in conjunction with authentication functions can also be used to encrypt data as it is transferred between computers. Encryption is preferably used at least for those transfers that pass through public data networks, such as the Internet. As a further, independent example, one or more documents to be printed may be compressed and combined into a single file with a separate “print options” file using the well-known ZIP file format.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected.

What is claimed is:

1. A system, comprising:
a local computer having a first processor and a first memory encoded with a first set of programming instructions executable by said first processor to:
execute a first instance of an application having at least one native data format; and
accept a request to print a first print job associated with the application;
a remote printer; and
a remote computer, in communication with said local computer and said remote printer, having a second processor and a second memory encoded with a second set of programming instructions executable by said second processor to:
execute a second instance of the application;
receive the request; and
in response to said receiving, automatically print the first print job on the remote printer using said second instance;
wherein the first print job is communicated from the local computer to the remote computer in one or more of the at least one native data formats.

2. The system of claim 1, further comprising a relay computer, configured and adapted to:
receive the first print job from said local computer;
send the first print job to said remote computer.

3. The system of claim 2, wherein said remote computer:
periodically polls said relay computer to determine whether one or more print jobs intended for said remote printer are waiting to be sent; and
if said one or more print jobs are waiting to be sent, retrieving said one or more print jobs, and printing them on said remote printer.

4. A system, comprising:
at least one remote printer;
a network; and
a local computer, connectable to at least one local printer, and in communication with said at least one remote printer via the network, comprising:
means for detecting whether one or more local printers are connected;
a processor; and
a memory encoded with programming instructions executable by said processor to:
maintain an ordered list of at least two printers, including at least one of said one or more local printers, and including at least one of said at least one remote printer;
accept a request to print a document;
automatically traverse the ordered list to find a destination printer, the first printer on the ordered list that is then accessible to said local computer; and
print the document on the destination printer.

5. The system of claim 4, wherein a first one of said local printers is directly connected to the local computer.

6. The system of claim 4, wherein a first one of said local printers is connected to the local computer through a local-area network.

7. The system of claim 4,
further comprising a remote computer in communication with said local computer; and
wherein said remote printer is connectable to said local computer through said remote computer.

8. The system of claim 7, wherein said remote printer is directly connected to said remote computer.

9. The system of claim 4, wherein the ordered list comprises a printer identifier identifying information for one or more printers in the ordered list.

10. The system of claim 4, wherein the ordered list comprises a group identifier for one or more printers in the ordered list.

11. A method, comprising:
receiving a print job from a source computer;
accepting a polling signal from a destination computer;
responding to the polling signal by sending the print job to the destination computer for printing on a printer that is directly connected or LAN-connected to the destination computer;
receiving a print job result signal from the destination computer; and
sending the print job result signal to the source computer.

12. The method of claim 11, wherein the print job comprises document data and printing parameters.

13. The method of claim 11, wherein the print job comprises document data in a format not directly printable by the remote printer.

14. The method of claim 13, wherein the format is a word processing application data format.

15. The method of claim 13, wherein the format is a spreadsheet application data format.

16. A method, comprising:
receiving a print job from a source computer;
detecting an enabling signal; and
after said detecting, sending the print job to a remote printer that is neither directly connected nor LAN-connected to the source computer.

17. The method of claim 16, wherein said receiving, detecting, and sending are performed by a relay server.

18. The method of claim 17, wherein:
the enabling signal is a polling signal from a destination computer; and
said sending comprises transmitting the print job to the destination computer for printing.

19. The method of claim 18, further comprising:
receiving a print job result signal from the destination computer; and
sending the print job result signal to the source computer.

20. The method of claim 16, wherein the print job comprises printable data and envelope data.

21. The method of claim 20, wherein the envelope data comprises document type information.

22. The method of claim 20, wherein the envelope data comprises authentication information.

23. The method of claim 16, wherein the remote printer is selected from a plurality of remote printers before said receiving.

24. The method of claim 16, wherein the remote printer is selected from a plurality of remote printers after said receiving.

25. The method of claim 16, wherein:
the print job is originated by a user associated with a user identifier; and
the remote printer is selected from a plurality of remote printers based on the user identifier.

26. The method of claim 16, wherein:
the source computer has a network address; and
the remote printer is selected from a plurality of remote printers based on the network address.

27. The method of claim 16, further comprising:
exposing a user interface to a user at the source computer;
displaying a list of available remote printers through the user interface;
accepting a selection of an available remote printer by the user through the user interface; and
transmitting the selection with the print job.
